(19) United States
(12) Patent Application Publication
(10) Pub. No.: US 2021/0310433 A1
(43) Pub. Date: Oct. 7, 2021

(54) SYSTEM AND METHODS FOR COMBUSTION CONTROLS IN MULTI-CYLINDER OPPOSED PISTON ENGINES

(71) Applicant: Cummins Inc., Columbus, IN (US)

(72) Inventors: J. Steven Kolhouse, Columbus, IN (US); Edmund P. Hodzen, Columbus, IN (US)

(73) Assignee: Cummins Inc., Columbus, IN (US)

(21) Appl. No.: 16/336,747

(22) PCT Filed: Sep. 25, 2017
(86) PCT No.: PCT/US2017/053206

§ 371 Date: Mar. 26, 2019

Related U.S. Application Data
(60) Provisional application No. 62/400,389, filed on Sep. 27, 2016.

(51) Int. Cl. F02D 41/14; F02D 41/40; F02D 35/02

(52) U.S. Cl. CPC F02D 41/1454; F02D 41/1463; F02D 2250/18; F02D 35/023; F02D 41/401

(57) ABSTRACT

A multi-cylinder opposed piston engine (100) can include one or more sensors, such as oxygen or nox sensors (132, 134, 136, 138, 142), for each cylinder (103) of the multi-cylinder opposed piston engine (100). The sensors (132, 134, 136, 138, 142) are in communication with an engine control unit (102) that can receive measurements and other data from the sensors. In one example, each cylinder (103) includes one or more sensors (132, 134) located adjacent to exhaust ports (144) of each individual cylinder (103). In another example, each cylinder (103) includes one or more sensors (136, 138) located in an exhaust passageway (146) of each individual cylinder (103). In some examples, the multi-cylinder opposed piston engine (100) can include multiple crankshafts (114, 116). For example, the multi-cylinder opposed piston engine (100) can include two crankshafts (114, 116), where each crankshaft (114, 116) engages, either directly or indirectly, one of two opposed pistons (104, 106) of a cylinder (103). In one example, each crankshaft (114, 116) includes one or more sensors, such as a torque sensor (120, 122), a speed sensor (124, 126), or a noise, vibration, and harshness (NVH) sensor (150, 152).

### CROSS-REFERENCE TO RELATED APPLICATIONS

This application claims the benefit of U.S. Provisional Patent Application 62/400,389, entitled SYSTEM AND METHODS FOR COMBUSTION CONTROL IN MULTI-CYLINDER OPPOSED PISTON ENGINES, filed Sep. 27, 2016, the disclosure of which is hereby incorporated by reference in its entirety.

### FIELD OF THE INVENTION

The present disclosure relates generally to opposed piston engines, and more particularly, to after treatment systems and controls for multi-cylinder opposed piston engines.

### BACKGROUND OF THE INVENTION

Multi-cylinder opposed piston engines include opposed pistons such that the opposed pistons move away from each other during combustion of an air and fuel mixture. Each cylinder includes associated intake ports which receive air via an intake manifold, and one or more fuel injectors that provide fuel to the cylinder. The combustion of the air and fuel mixture allows the cylinders to drive one or more crankshafts. As a result of the combustion, exhaust gases vacate each cylinder via exhaust ports coupled to an exhaust manifold.

Combustion engines, including multi-cylinder opposed piston engines, typically need to meet emissions standards to be allowed to operate in various environments. As such, combustion engines employ after treatment systems to regulate and monitor exhaust gas. These after treatment systems often employ sensors to monitor levels of various exhaust gas properties. The monitored levels can be used by an after treatment system to adjust exhaust gas treatment, such as to adjust the capturing of particles. However, the monitoring of exhaust gas properties can present challenges to determining the cause or location of a problem in multi-cylinder opposed piston engines. For example, engine operating conditions can include engine misfirings, auto ignition, one or more cylinder pressures exceeding a maximum threshold, air-fuel-ratios, or nitrogen oxide (NOx) levels exceeding a threshold, among others. If one or more of these engine operating conditions become unacceptable, the cause or location of the problem may be difficult to determine. Accordingly, there are opportunities to address the monitoring of exhaust gases in multi-cylinder opposed piston engines.

### SUMMARY

A multi-cylinder opposed piston engine can include one or more sensors, such as oxygen or NOx sensors, for each cylinder of the multi-cylinder opposed piston engine. The sensors are in communication with an engine control unit (ECU) that can receive measurements and other data from the sensors. In one example, each cylinder includes one or more sensors located adjacent to the exhaust ports of each individual cylinder. In another example, each cylinder includes one or more sensors located in an exhaust passageway of each individual cylinder. These configurations may allow the sensors to test exhaust gas exiting a cylinder with minimum contamination from exhaust gasses leaving other cylinders.

Each cylinder can also include an internal cylinder pressure sensor (ICPS) for measuring the cylinder's internal pressure during, or after, combustion. An ECU can receive measurements and related data from each ICPS associated with each cylinder. Additionally or alternatively, each cylinder can also include an ignition assist device (IAD), such as an electrical spark plug, a glow plug, a laser ignition device, or a plasma ignition device, for example, as is recognized in the art. The ECU can provide control signals to, and/or receive measurements and related data from, each IAD.

Additionally or alternatively, the multi-cylinder opposed piston engine can include one or more sensors, such as an oxygen or NOx sensor, that are downstream of the cylinders. These additional sensors can be located either before (e.g., upstream), or after (e.g., downstream), the location of after treatment (AT) devices and operate as engine-out sensors or system-out sensors, respectively. Examples of AT devices include, for example, a diesel oxidation catalyst (DOC) to reduce carbon monoxide (CO) and hydrocarbons, a diesel particulate filter (DPF) to reduce soot emissions, a selective catalytic reduction device to reduce NOx emissions, or a three way catalyst (TWL), as known in the art. These sensors are in communication with the ECU such that they can provide measurements and other data to the ECU.

In some examples the multi-cylinder opposed piston engine can include multiple crankshafts. For example, the multi-cylinder opposed piston engine can include two crankshafts, where each crankshaft engages, either directly or indirectly, one of two opposed pistons of a cylinder. In one example, each crankshaft includes one or more sensors, such as a torque sensor, a speed sensor, or a noise, vibration, and harshness (NVH) sensor. As is known in the art, torque sensors are capable of measuring a rotational force, speed sensors are capable of measuring a rotational speed, and NVH sensors are capable of measuring vibrations. In one example, each crankshaft includes a torque sensor, a speed sensor, and an NVH sensor.

Because the ECU is in communication with the various sensors and devices, the ECU can adjust operation of the multi-cylinder opposed piston engine such as by adjusting individual cylinder air, fuel, or ignition operations (e.g., parameters) in response to unacceptable engine operating conditions. For example, the ECU can measure and/or estimate unacceptable engine operating conditions based on feedback from oxygen, ICPS, NOx, torque, or speed sensors. In response, the ECU can adjust fuel injection timing, fuel injection quantity, or the injection mix of two different fuel types. The ECU can also initiate multiple fuel injection events including post-injection. In one example, the ECU can independently control multiple (e.g., 2) fuel injectors of a same cylinder with regard to start-of-injection (SOI), injection rates, injection quantities, and/or multiple injection events. In one example, the ECU independently controls fuel injectors of multiple cylinders with regard to start-of-injection (SOI), injection rates, injection quantities, and/or multiple injection events.

Similarly, the ECU can adjust air-fuel ratios (e.g., lambda), inlet throttle valve positions, or intake port timings in response to the measured or estimated engine operating conditions. The ECU may also adjust ignition events such as spark timing, spark intensity, spark events, or micro-pilot fuel injection timing and/or quantity. For example, the ECU can measure, monitor, estimate, or diagnose catalyst conversion efficiency using data received from NOx sensors located upstream, and downstream, of AT devices.

In one example, by providing for an ECU to communicate with a torque sensor for each of a plurality of crankshafts (e.g., 2), the multi-cylinder opposed piston engine provides redundancy in the event of a single torque sensor failure. For example, the multi-cylinder opposed piston engine can include two crankshafts each including an associated torque sensor in communication with an ECU. If one torque sensor fails, the ECU can still measure or estimate crankshaft torque based on readings from the still operable torque sensor.

The multi-cylinder opposed piston engine can allow for advanced cylinder-balancing techniques via individual cylinder adjustments to fueling and/or air handling to minimize output torque variations between cylinders. Similarly, the multi-cylinder opposed piston engine allows for advanced diagnostics (OBD) capability by way of monitoring torque output from each combustion event. For example, the ECU, via received measurement data from each of an intake-side crankshaft torque sensor associated with an intake-side crankshaft and an exhaust-side crankshaft torque sensor associated with an exhaust-side crankshaft, can monitor and compare intake-side output torque and exhaust-side output torque for each crankshaft. As another example, the ECU can monitor total output torque (e.g., intake-side output torque plus exhaust-side output torque) of each cylinder. The ECU can also make individual cylinder adjustments, such as the ones discussed above, to minimize total output torque variations across the individual cylinders.

Corresponding methods are provided for controlling a multi-cylinder opposed piston engine that include one or more sensors, such as oxygen or NOx sensors, for each cylinder of the multi-cylinder opposed piston engine. The method can include adjusting one or more individual cylinder air, fuel, or ignition parameters in response to unacceptable engine operating conditions. In one example, the unacceptable engine operating conditions are determined based on data received from one or more sensors associated with each cylinder. In another example, individual cylinder adjustments to fueling and/or air handling are made to reduce output torque variations between cylinders.

A first aspect of the present disclosure provides a multi-cylinder opposed piston engine system having at least one opposed piston cylinder into which a mixture of combustible fuel and air is provided via an intake manifold of an engine to drive at least one crankshaft; at least one of an oxygen sensor, a nitrogen oxide sensor, both the oxygen sensor and the nitrogen oxide sensor being located within an exhaust passageway of the at least one opposed piston cylinder, and a pressure sensor in communication with the at least one opposed piston cylinder; and an engine control unit operably coupled to the at least one of the oxygen sensor and nitrogen oxide sensor and operable to: receive data from the at least one of the oxygen sensor and nitrogen oxide sensor; and adjust at least one operating condition of the multi-cylinder opposed piston engine system in response to the received data.

In one example, the adjusted at least one operating condition comprises one or more parameters relating to at least one of: a cylinder air, fuel, or ignition operation of the engine.

A second aspect of the present disclosure provides a multi-cylinder opposed piston engine system having at least one opposed piston cylinder into which a mixture of combustible fuel and air is provided via an intake manifold of an engine to drive a first crankshaft and a second crankshaft; a first torque sensor coupled to one of the first crankshaft and the second crankshaft; and an engine control unit operably coupled to the first torque sensor and operable to: receive data from the first torque sensor; and adjust at least one operating condition of the multi-cylinder opposed piston engine system in response to the received data.

In one example, the multi-cylinder opposed piston engine system includes a first noise, vibration, and harshness sensor coupled to the first crankshaft; and a second noise, vibration, and harshness sensor coupled to the second crankshaft, wherein the engine control unit is operably coupled to the first noise, vibration, and harshness sensor and to the second noise, vibration, and harshness sensor.

A third aspect of the present disclosure provides a method of controlling a multi-cylinder opposed piston engine system. The method includes receiving data from a first torque sensor and a first speed sensor each coupled to a first crankshaft; receiving data from a second torque sensor and a second speed sensor each coupled to a second crankshaft; and adjusting at least one operating condition of the multi-cylinder opposed piston engine system in response to the data received from the first torque sensor, the first speed sensor, the second torque sensor, and the second speed sensor.

In one example, the method further includes determining at least one unacceptable engine operating condition in response to the received data, wherein adjusting the at least one operating condition of the multi-cylinder opposed piston engine system comprises adjusting at least one individual cylinder air, fuel, or ignition operation in response to the determined at least one unacceptable engine operating condition.

A fourth aspect of the present disclosure provides a method of controlling a multi-cylinder opposed piston engine system. The method includes receiving data from at least one of an oxygen sensor and a nitrogen oxide sensor located within an exhaust passageway of at least one opposed piston cylinder; and adjusting at least one operating condition of the multi-cylinder opposed piston engine system in response to the received data.

In one example, adjusting the at least one operating condition of the multi-cylinder opposed piston engine system comprises adjusting at least one of fueling and air handling of a first opposed piston cylinder to reduce output torque variations between the first opposed piston cylinder and a second opposed piston cylinder.

A fifth aspect of the present disclosure provides a multi-cylinder opposed piston engine system having at least two opposed piston cylinders into which a mixture of combustible fuel and air is provided via intake ports of an engine, and from which exhaust gases are released via exhaust ports; at least one oxygen sensor and at least one nitrogen oxide sensor located within an exhaust passageway of a corresponding opposed piston cylinder; and an engine control unit operably coupled to the at least one oxygen sensor and the at least one nitrogen oxide sensor and operable to: receive data from the at least one oxygen sensor and the at least one nitrogen oxide sensor; and adjust at least one operating condition of the multi-cylinder opposed piston engine system in response to the received data.

In one example, the at least one oxygen sensor and the at least one nitrogen oxide sensor are placed adjacent to and separately associated with the corresponding opposed piston cylinder. In another example, the engine control unit is operable to receive the data associated with the corresponding opposed piston cylinder. In yet another example, the at least one oxygen sensor and the at least one nitrogen oxide sensor are located downstream of the exhaust ports for receiving the data associated with two or more of the at least two opposed piston cylinders. In still another example, the engine control unit is operable to receive the data associated with the two or more of the at least two opposed piston cylinders. In still yet another example, the multi-cylinder opposed piston engine system further includes an after treatment device operatively coupled to the exhaust ports. In a further example, the at least one oxygen sensor and the at least one nitrogen oxide sensor are located upstream of the after treatment device. In yet a further example, the at least one oxygen sensor and the at least one nitrogen oxide sensor are located downstream of the after treatment device.

A sixth aspect of the present disclosure provides a method of controlling a multi-cylinder opposed piston engine system. The method includes providing at least two opposed piston cylinders into which a mixture of combustible fuel and air is provided via intake ports of an engine, and from which exhaust gases are released via exhaust ports; disposing at least one oxygen sensor and at least one nitrogen oxide sensor within an exhaust passageway of a corresponding opposed piston cylinder; operably coupling an engine control unit to the at least one oxygen sensor and the at least one nitrogen oxide sensor; receiving data from the at least one oxygen sensor and the at least one nitrogen oxide sensor; and adjusting at least one operating condition of the multi-cylinder opposed piston engine system in response to the received data.

In one example, the method further includes placing the at least one oxygen sensor and the at least one nitrogen oxide sensor adjacent to the corresponding opposed piston cylinder for separately associating with the corresponding opposed piston cylinder. In another example, the method further includes placing the at least one oxygen sensor and the at least one nitrogen oxide sensor downstream of the exhaust ports for receiving the data associated with two or more of the at least two opposed piston cylinders. In still another example, the method further includes placing the at least one oxygen sensor and the at least one nitrogen oxide sensor downstream of an after treatment device operatively coupled to the exhaust ports.

### BRIEF DESCRIPTION OF THE DRAWINGS

The embodiments will be more readily understood in view of the following description when accompanied by the below figures and wherein like reference numerals represent like elements, wherein:

FIG. 1 is a block diagram of one illustrative embodiment of a multi-cylinder opposed piston engine having various sensors and an engine control unit;

FIG. 2 is a block diagram of one illustrative embodiment of the engine control unit of FIG. 1 in communication with various sensors;

FIG. 3 is a flowchart of one illustrative process executed by the engine control unit of FIG. 1; and

FIG. 4 is a flowchart of another illustrative process executed by the engine control unit of FIG. 1.

### DETAILED DESCRIPTION OF EMBODIMENTS

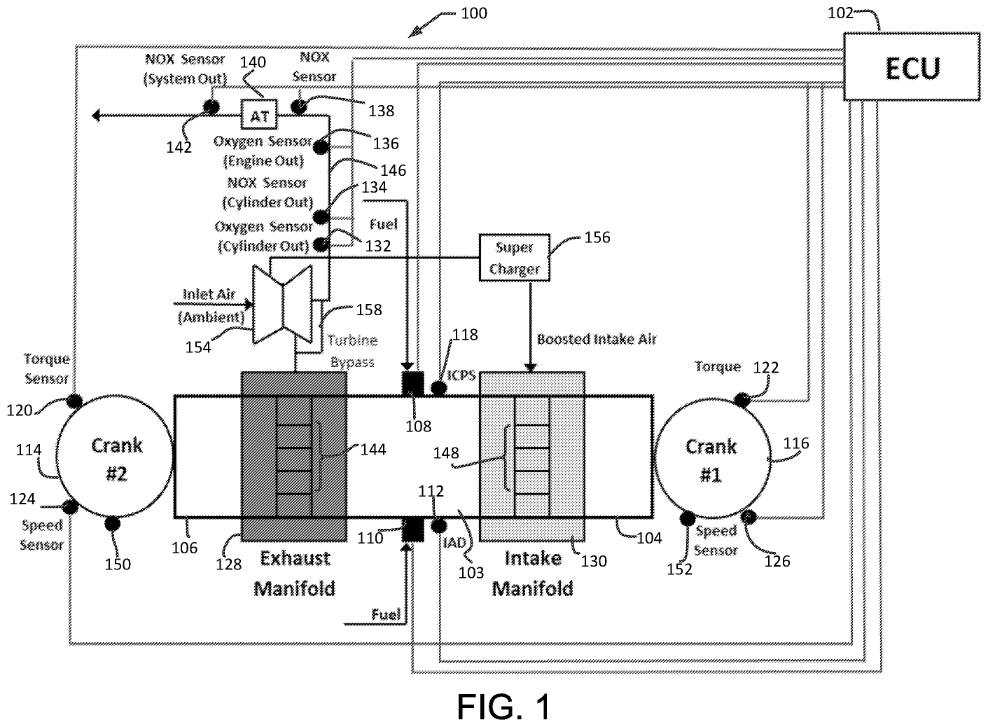

Referring to FIG. 1, a block diagram is shown of one illustrative embodiment of a multi-cylinder opposed piston engine 100 including an engine control unit (ECU) 102 and cylinder 103 that includes opposed pistons 104, 106. ECU 102 can include one or more processors, such as a central processing unit (CPU), microcontrollers, processing cores, or any other suitable processing devices executing suitable instructions. In some examples, ECU 102 can include one or more field programmable gate arrays (FPGA), integrated circuits (IC) such as application-specific integrated circuits (ASIC), and any other suitable logic. Although only one cylinder 103 is shown, the multi-cylinder opposed piston engine 100 can include multiple cylinders as is recognized in the art. The cylinder 103 includes fuel injectors 108, 110, ignition assist device (IAD) 112, and internal cylinder pressure sensor (ICPS) 118. The ECU 102 is in communication with fuel injectors 108, 110, IAD 112 and ICPS 118.

The cylinder's 103 opposed pistons 104, 106 are associated with crankshafts 116, 114, respectively. For example, during combustion of an air and fuel mixture, opposed piston 106 drives crankshaft 114, while opposed piston 104 drives crankshaft 116. Crankshaft 114 may be considered an exhaust-side crankshaft as it is closest to exhaust manifold 128. Similarly, crankshaft 116 may be considered an intake-side crankshaft, as it is closest to intake manifold 130. As illustrated, crankshaft 114 includes torque sensor 120 and crankshaft 116 includes torque sensor 122. Additionally, crankshaft 114 includes speed sensor 124 and crankshaft 116 includes speed sensor 126. ECU 102 is in communication with the torque sensors 120, 122 and the speed sensors 124, 126. ECU 102 can receive data (e.g., measurements) from torque sensors 120, 122, such as crankshaft torque data. Similarly, ECU 102 can receive data from speed sensors 124, 126, such as crankshaft speed data. In some embodiments, crankshaft 114 includes NVH sensor 150 and crankshaft 116 includes NVH sensor 152. ECU 102 is in communication with the NVH sensors 150, 152, and can receive data (e.g., measurements) from NVH sensors 150, 152, such as noise, vibration, and harshness data.

In the illustrated embodiment, cylinder 103 is operably coupled to exhaust manifold 128 and to intake manifold 130. For example, cylinder 103 can receive air via intake ports 148 coupled to intake manifold 130 to mix with fuel received via fuel injectors 108, 110 for combustion. Exhaust gases can be released from cylinder 103 during or after combustion via one or more exhaust ports 144 operatively coupled to exhaust manifold 128. As the exhaust gases leave exhaust ports 144, they enter exhaust passageway 146.

In one example, ambient intake air is provided to intake manifold 130 via intake ports 148 using a first compressor 154, such as a turbocharger and a second compressor 156, such as a supercharger. In another example, a turbine bypass 158 is provided for bypassing first compressor 154, as desired. Other suitable combinations and configurations of compressors and relevant components are also contemplated to suit different applications.

As other exemplary system architectures, multi-cylinder opposed piston engine 100 includes real-time torque sensors on at least one of the two crankshafts, oxygen (lambda) sensors in the exhaust port of each individual cylinder and/or in a common exhaust gas collector downstream of all cylinders, NOx sensors in the exhaust port of each individual cylinder, NOx sensors in the exhaust path upstream and/or downstream of aftertreatment (AT) device(s), In-Cylinder Pressure (ICPS) sensors in one or more of the combustion cylinders, and Ignition Assist Device (IAD) in each of the combustion cylinders. In other embodiments, Ignition Assist Devices (IAD) includes electrical spark plug(s), glow plug(s), laser ignition, or plasma ignition types. In some embodiments, engine 100 utilizes diesel micro-pilot ignition in lieu of Ignition Assist Device (IAD).

In this illustrative embodiment, oxygen sensor 132 and NOx sensor 134 are located in the exhaust passageway 146 of cylinder 103. As such, oxygen sensor 132 and NOx sensor 134 can monitor the exhaust gases as they leave cylinder 103 via the exhaust passageway 146 of cylinder 103. Oxygen sensor 132 and NOx sensor 134 are in communication with ECU 102. ECU 102 can receive data (e.g., measurements) from oxygen sensor 132 such as data including exhaust gas oxygen level data. Similarly, ECU 102 can receive data (e.g., measurements) from NOx sensor 134 such as data including exhaust gas NOx level data.

Additionally, oxygen sensor 136 is located in a common exhaust gas collector of the exhaust manifold 128, which may be downstream of the exhaust passageway 146 of cylinder 103. For example, assuming multiple cylinders, the common exhaust gas collector may receive exhaust gases from one or more cylinders. As such, oxygen sensor 136 is located such that it can monitor gases received from one or more cylinders. Similarly, NOx sensor 138 is located in a common exhaust gas collector of the exhaust manifold 128. Assuming multiple cylinders, NOx sensor 138 can monitor gases received from one or more cylinders. As illustrated, oxygen sensor 136 and NOx sensor 138 are located upstream of after treatment device 140, and thus can monitor exhaust gases before the exhaust gases are treated by after treatment device 140. Each of oxygen sensor 136 and NOx sensor 138 are in communication with ECU. 102. ECU 102 can receive data from oxygen sensor 136 and NOx sensor 138

As illustrated, NOx sensor 142 is located downstream of after treatment device 140. ECU 102 is in communication with NOx sensor 142 and can receive data from NOx sensor 142. Although not illustrated, additional sensors, such as oxygen sensors, can be located downstream of after treatment device 140.

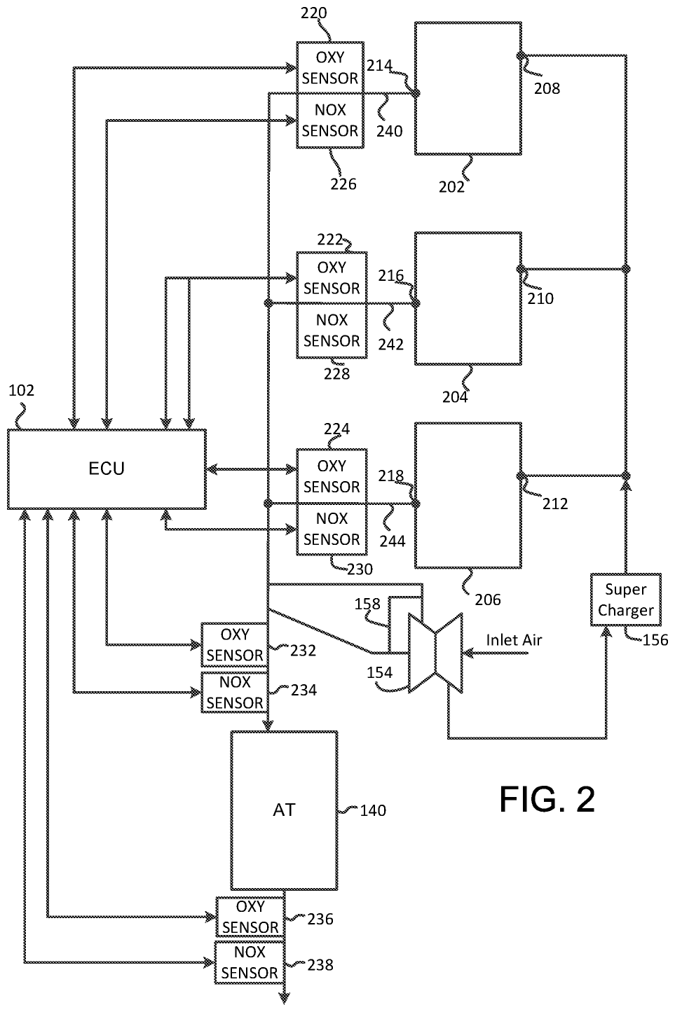

Referring to FIG. 2, the ECU 102 of FIG. 1 is illustrated in communication with various sensors. As shown, multiple opposed piston cylinders 202, 204, 206 receive air via intake ports 208, 210, 212, respectively. For example, as similarly shown in FIG. 1, ambient inlet air is provided to intake ports 208, 210, 212 using first compressor 154 (e.g., turbocharger) and second compressor 156 (e.g., supercharger). In another example, turbine bypass 158 is provided for bypassing first compressor 154, as desired. Other suitable combinations and configurations of compressors and relevant components are also contemplated to suit different applications.

Cylinders 202, 204, 206 receive fuel via fuel injectors (not shown), and mix it with the received air to combust. Exhaust ports 214, 216, 218 allow for the release of exhaust gases from cylinders 202, 204, 206, respectively, during or after combustion. As indicated in FIG. 2, each exhaust port 214, 216, 218 leads to an exhaust passageway 240, 242, 244, where each is operatively coupled to an oxygen sensor and a NOx sensor. Specifically, exhaust passageway 240 includes oxygen sensor 220 and NOx sensor 226. Similarly, exhaust passageway 242 includes oxygen sensor 222 and NOx sensor 228, and exhaust passageway 244 includes oxygen sensor 224 and NOx sensor 230. In one example, one or more of the oxygen sensors 220, 222, 224 and NOx sensors 226, 228, 230 are placed just outside or adjacent to and separately associated with the corresponding exhaust ports 214, 216, 218. Each of oxygen sensors 220, 222, 224 and NOx sensors 226, 228, 230 are in communication with ECU 102 and can provide data to ECU 102.

ECU 102 is also in communication with other sensors as well. As illustrated, ECU 102 is in communication with oxygen sensor 232 and NOx sensor 234. Each of oxygen sensor 232 and NOx sensor 234 are located downstream of exhaust ports 214, 216, 218, and upstream of after treatment device 140. ECU 102 is also in communication with oxygen sensor 236 and NOx sensor 238, which are located downstream of after treatment device 140. Each of oxygen sensors 232, 236 and NOx sensors 234, 238 can provide data to ECU 102.

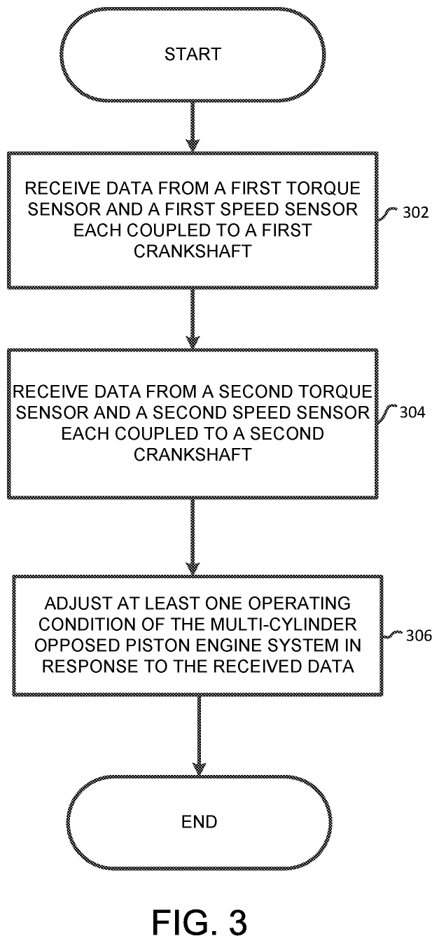

FIG. 3 is flowchart illustrating an example method that can be performed by, for example, ECU 102 of FIG. 1. At step 302, data is received from a first torque sensor and a first speed sensor, where each of the sensors is coupled to a first crankshaft. At step 304, data is received from a second torque sensor and a second speed sensor, where each of the sensors is coupled to a second crankshaft. Proceeding to step 306, at least one operating condition of the multi-cylinder opposed piston engine system is adjusted in response to the received data. For example, an ECU may adjust injection quantities to a fuel injector of a cylinder is response to receiving data from the torque and/or speed sensors indicating uneven (e.g., unequal) torques and/or speeds.

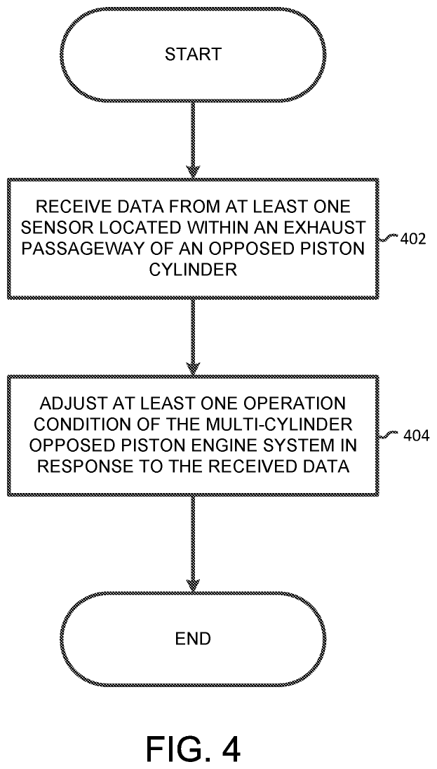

FIG. 4 is flowchart illustrating an example method that can be performed by, for example, ECU 102 of FIG. 1. The method begins at step 402, where data is received from at least one sensor located within an exhaust passageway of an opposed piston cylinder. At step 404, at least one operating condition of the multi-cylinder opposed piston engine system is adjusted in response to the received data. For example, an ECU may adjust individual cylinder air, fuel, or ignition operations in response to the received data, such as when the ECU receives data from an oxygen or NOx sensor indicating unacceptable oxygen or NOx levels.

In embodiments, ECU 102 adjusts individual cylinder air, fuel, or ignition parameters in response to unacceptable engine operating conditions. For example, unacceptable engine operating conditions include the following scenarios: engine misfire, auto-ignition, cylinder pressure exceeding a threshold, air-fuel-ratio error vs. target, engine-out and/or system-out NOx levels exceeding a threshold or target. As another example, unacceptable NVH between cylinders (i.e. cylinder balancing), unacceptable catalyst conversion efficiencies, etc. Unacceptable operating conditions are measured and/or estimated based on feedback from Torque, Oxygen, ICPS, NOx, and/or Engine Speed sensors. Fuel parameters include fuel injection timing, fuel injection quantity, initiating multiple fuel injection events including post-injection, or adjusting the injection mix of two different fuel types. Air parameters include air-fuel ratio (lambda), inlet throttle valve position, intake port timing. Ignition parameters include spark timing, spark intensity, multiple spark events, or micro-pilot fuel injection timing/quantity.

In other embodiments, ECU 102 can measure, monitor, and/or diagnose catalyst conversion efficiency using upstream and/or downstream NOX sensors. Independent control of the two (2) fuel injectors with regard to start-of-injection (SOI), injection rates, injection quantities, multiple injection events, etc. Use of real-time torque sensor for each crankshaft enables the following, for example, redundancy for overall engine system in the event of a single torque sensor failure; advanced cylinder-balancing techniques via individual cylinder adjustments to fueling and/or air handling to minimize output torque variations between cylinders; and advanced Diagnostics (OBD) capability by way of monitoring torque output from each combustion event. In another example, ECU 102 can monitor intake-side output torque vs. exhaust-side output torque for each cylinder, can monitor total output torque (intake+exhaust) of each cylinder, and can make individual cylinder adjustments (air, fuel, spark) to minimize total output torque variation across the individual cylinders.

The above detailed description and the examples described therein have been presented for the purposes of illustration and description only and not for limitation. For example, the operations described can be done in any suitable manner. The methods can be performed in any suitable order while still providing the described operation and results. It is therefore contemplated that the present embodiments cover any and all modifications, variations, or equivalents that fall within the scope of the basic underlying principles disclosed above and claimed herein. Furthermore, while the above description describes hardware in the form of a processor executing code, hardware in the form of a state machine, or dedicated logic capable of producing the same effect, other structures are also contemplated.

1. A multi-cylinder opposed piston engine system comprising:
at least one opposed piston cylinder into which a mixture of combustible fuel and air is provided via an intake manifold of an engine to drive at least one crankshaft;
at least one of: an oxygen sensor; a nitrogen oxide sensor; and a pressure sensor, both the oxygen sensor and the nitrogen oxide sensor being located within an exhaust passageway of the at least one opposed piston cylinder, and the pressure sensor being in communication with the at least one opposed piston cylinder; and
an engine control unit operably coupled to the at least one of the oxygen sensor and nitrogen oxide sensor and operable to:
receive data from the at least one of the oxygen sensor and nitrogen oxide sensor; and
adjust at least one operating condition of the multi-cylinder opposed piston engine system in response to the received data, the at least one operating condition relating to at least one of: a fuel injection timing, a fuel injection quantity, and an injection mix of at least two different fuel types.

2. The multi-cylinder opposed piston engine system of claim 1, wherein the adjusted at least one operating condition comprises one or more parameters relating to at least one of: a cylinder air, fuel, or ignition operation of the engine.

3-6. (canceled)

7. A method of controlling a multi-cylinder opposed piston engine system, the method comprising:
receiving data from at least one of an oxygen sensor and a nitrogen oxide sensor located within an exhaust passageway of at least one opposed piston cylinder; and
adjusting at least one operating condition of the multi-cylinder opposed piston engine system in response to the received data, the at least one operating condition relating to at least one of: a fuel injection timing, a fuel injection quantity, and an injection mix of at least two different fuel types.

8. The method of claim 7, wherein adjusting the at least one operating condition of the multi-cylinder opposed piston engine system comprises adjusting at least one of fueling and air handling of a first opposed piston cylinder to reduce output torque variations between the first opposed piston cylinder and a second opposed piston cylinder.

9. A multi-cylinder opposed piston engine system comprising:
at least two opposed piston cylinders into which a mixture of combustible fuel and air is provided via intake ports of an engine, and from which exhaust gases are released via exhaust ports;
at least one of: an oxygen sensor and a nitrogen oxide sensor located within an exhaust passageway downstream of an after treatment device of the engine; and
an engine control unit operably coupled to the at least one of: the oxygen sensor and the nitrogen oxide sensor and operable to:
receive data from the at least one of: the oxygen sensor and the nitrogen oxide sensor; and
adjust at least one operating condition of the multi-cylinder opposed piston engine system in response to the received data.

10. (canceled)

11. The multi-cylinder opposed piston engine system of claim 9, wherein the engine control unit is operable to receive the data associated with a corresponding opposed piston cylinder of the engine.

12-16. (canceled)

17. A method of controlling a multi-cylinder opposed piston engine system, the method comprising:
providing at least two opposed piston cylinders into which a mixture of combustible fuel and air is provided via intake ports of an engine, and from which exhaust gases are released via exhaust ports;
disposing at least one of: an oxygen sensor and a nitrogen oxide sensor within an exhaust passageway downstream of an after treatment device of the engine;
operably coupling an engine control unit to the at least one of: the oxygen sensor and the nitrogen oxide sensor;
receiving data from the at least one of: the oxygen sensor and the nitrogen oxide sensor; and
adjusting at least one operating condition of the multi-cylinder opposed piston engine system in response to the received data.

18-20. (canceled)
